(19) United States
(12) Patent Application Publication
(10) Pub. No.: US 2003/0189324 A1
(43) Pub. Date: Oct. 9, 2003

(54) Tear seam pattern for vehicle instrument panel

(76) Inventors: Mathew L. Nassoiy, Milford, MI (US); Janice L. Woolley, Goodrich, MI (US)

Correspondence Address: LAURA C. HARGITT, General Motors Corporation, Legal Staff, Mail Code 482-C23-B21, P.O. Box 300, Detroit, MI, 48265-3000, US

(21) Appl. No.: 10/116,695

(22) Filed: Apr. 3, 2002

(51) Int. Cl. B60R 21/16

(52) U.S. Cl. 280/732

(57) ABSTRACT

An instrument panel for a vehicle includes an air bag positioned for deployment through an instrument panel member. The instrument panel member has a tear seam formed therein to facilitate such deployment. The tear seam is configured to define four separate pivotable deployment panels in the instrument panel member. Each deployment panel is pivotable in a direction away from the air bag as it deploys.

### BACKGROUND OF THE INVENTION

1. Field of the Invention

The present invention relates to a tear seam pattern for a vehicle instrument panel in which the tear seam is configured to define four separate pivotable deployment panels, each of which is pivotable in a direction away from the air bag as it deploys.

2. Background Art

Many vehicles include passenger air bags which deploy from the instrument panel of the vehicle to protect the passenger in a collision. Recently, the National Highway Traffic Safety Administration (NHTSA) has defined certain out-of-position test requirements and corresponding injury response values in FMVSS 208. These safety standards address injury rates for passengers which are out-of-position during a collision, such as children who are not wearing a safety restraint. It is, of course, desirable to reduce injury response values in these positions to satisfy NHTSA standards and improve vehicle safety.

It may also be desirable to avoid contact of a deploying air bag door with the vehicle windshield to prevent shattering of the windshield and tearing of the air bag during deployment.

### SUMMARY OF THE INVENTION

The present invention addresses the above-referenced out-of-position performance requirements for passenger air bag assemblies by providing a tear seam configuration which defines four separate pivotable deployment panels so that the rearward deployment panel is short enough to avoid contact with the out-of-position passenger, and the forward deployment panel is short enough to avoid contact with the front windshield during deployment.

More specifically, the invention provides an instrument panel for a vehicle having an air bag positioned for deployment through an instrument panel member. The instrument panel member has a tear seam formed therein to facilitate such deployment. The tear seam is configured to define four separate pivotable deployment panels in the instrument panel member. Each such panel is pivotable in a direction away from the air bag as it deploys.

Two of the four pivotable deployment panels are cross-car deployment panels which are positioned to pivot laterally in the vehicle during deployment. These two panels may have different lengths. For example, the panel nearest the side of the vehicle may be shorter so that it does not contact the side of the vehicle. The distal ends of the two cross-car deployment panels are arranged to abut each other, but separated by a portion of the tear seam.

A third of the four pivotable deployment panels is positioned to pivot toward a windshield of the vehicle without contacting the windshield during deployment. A fourth of the four pivotable deployment panels is positioned to pivot toward a vehicle occupant without contacting the occupant during deployment, and to direct the deploying air bag angularly upward away from the occupant during an early stage of deployment of the air bag.

The ends or corners of the tear seam may include curved portions to prevent tearing of the instrument panel member as the panels deploy.

The “instrument panel member” in which the tear seam is formed may be the instrument panel substrate, a cover module of the air bag assembly which is positioned beneath a substrate, a deployment guide bracket, or an air bag cover module having a class “A” surface.

Another aspect of the invention provides a vehicle instrument panel member tear seam pattern which includes a straight first portion having first and second ends. Second and third straight, parallel portions intersect the first and second ends, respectively, and each of the second and third straight, parallel portions are perpendicular to the first portion. Also, the second and third straight, parallel portions each have two distal ends. Fourth, fifth, sixth and seventh straight, parallel portions each intersect a respective distal end of the second or third straight, parallel portions. Also, each of the fourth, fifth, sixth and seventh straight, parallel portions are parallel with the first portion. The fourth, fifth, sixth and seventh straight, parallel portions have curved ends to prevent tearing of the instrument panel member during deployment.

The above objects, aspects, features, advantages, and other objects, aspects, features and advantages of the present invention are readily apparent from the following detailed description of the best mode for carrying out the invention when taken in connection with the accompanying drawings.

### BRIEF DESCRIPTION OF THE DRAWINGS

FIG. 1 shows a plan view of an instrument panel member incorporating a tear seam in accordance with the present invention;

FIG. 2 shows a side cross-sectional view of an air bag deploying through a vehicle instrument panel adjacent a seated anthropomorphic test device;

FIG. 3 shows a vertical cross-sectional view of a deploying air bag, air bag module and instrument panel, as shown in FIG. 2; and

FIG. 4 shows a schematic perspective view illustrating deployment of the pivotable deployment panels of the instrument panel member.

### DETAILED DESCRIPTION OF THE PREFERRED EMBODIMENT

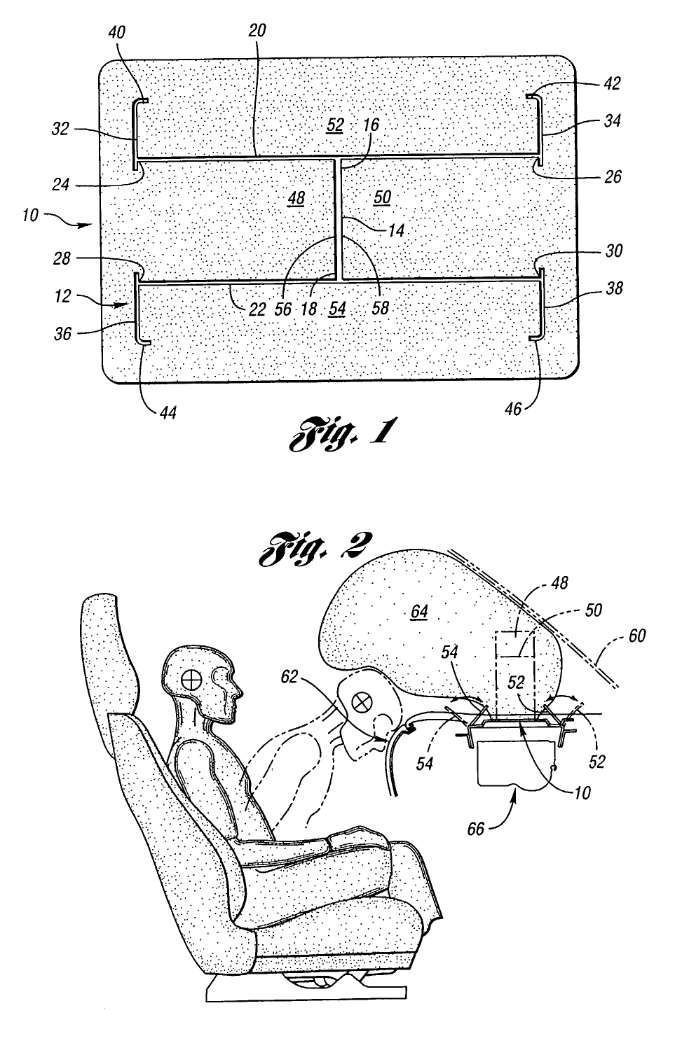

Referring to FIG. 1, an instrument panel member 10 is shown, and includes the tear seam 12 formed therein to facilitate deployment of an air bag through the instrument panel member 10. FIG. 1 also shows an anthropomorphic test device which illustrates, in phantom, an out-of-position passenger.

The instrument panel member 10 in which the tear seam 12 is formed may be an instrument panel substrate. The substrate would be covered by foam and a skin to complete the instrument panel assembly. An air bag would be deployed through the tear seam 12 of the substrate, and would burst through the foam and skin of the instrument panel. The tear seam may be formed fully through the substrate, or the tear seam may be formed by thinned-down or weakened sections of the substrate, such as by laser-etching the tear seam pattern to a predetermined depth within the substrate.

Alternatively, the instrument panel member 10 may be a cover for an air bag module. The cover may have a class “A” surface and include an integral foam and skin thereon.

In a further embodiment, the instrument panel member may be a cover on an air bag module, and the cover would be positioned against the underside of an instrument panel substrate. The tear seam may be formed fully through the cover, or the tear seam may only be formed by weakened or thinned-down portions of the cover (i.e., the tear seam pattern may be cut in to a predetermined depth). The substrate would also be provided with corresponding weakened areas to facilitate deployment. In other words, the cover and substrate would have similar tear seam patterns formed therein or therethrough.

In a further embodiment, the instrument panel member may be a hinge/bracket configuration which is connected to the underside of an instrument panel substrate. The tear seam configuration would be formed both in the hinge/bracket and in the substrate.

It is contemplated that the instrument panel member 10 having a tear seam 12 formed therein may comprise any of a variety of instrument panel or air bag module assembly components within the scope of the present invention.

As further shown in FIG. 1, the tear seam 12 includes a straight first portion 14 which is to be arranged lengthwise with respect to the length of the vehicle. The straight first portion 14 has first and second ends 16,18, respectively. Second and third straight, parallel portions 20,22, respectively, intersect the first and second ends 16,18, respectively, of the straight first portion 14. The second and third straight, parallel portions 20,22 are each perpendicular to the straight first portion 14. Also, the second and third straight, parallel portions 20,22 each have two distal ends 24, 26, 28, 30, respectively. A fourth straight, parallel portion 32 intersects the distal end 24 of the second straight, parallel portion 20. A fifth straight, parallel portion 34 intersects the distal end 26 of the second straight, parallel portion 20. A sixth straight, parallel portion 36 intersects the distal end 28 of the third straight, parallel portion 22. A seventh straight, parallel portion 38 intersects the distal 30 of the third straight, parallel portion 22. The fourth, fifth, sixth and seventh straight, parallel portions 32, 34, 36, 38 are each parallel with the first portion 14 and perpendicular with the second and third straight, parallel portions 20,22.

As further shown in FIG. 1, the fourth, fifth, sixth and seventh straight, parallel portions 32, 34, 36, 38 each has a curved end 40, 42, 44, 46, respectively. The curved ends 40, 42, 44, 46 are provided to prevent tearing of the instrument panel member 10 as the air bag deploys through the tear seam 12. As shown in FIG. 1, the tear seam 12 defines four separate pivotable deployment panels 48, 50, 52, 54 in the instrument panel 10. Each of these deployment panels 48, 50, 52, 54 is pivotable in a direction away from the air bag as it deploys.

The first and second deployment panels 48,50 are cross-car deployment panels which are positioned to pivot laterally in the vehicle during deployment. The distal ends 56,58 of the cross-car deployment panels 48,50 are arranged to extend toward each other, separated only by the straight first portion 14 of the tear seam 12. The second deployment panel 50 may be shorter than the first deployment panel 48 so that the second deployment panel 50 does not contact the windshield or the side of the vehicle during deployment.

The third deployment panel 52 is positioned to pivot toward the windshield 60 of the vehicle, as shown in FIG. 2, without contacting the windshield 60 during deployment. The fourth deployment panel 54 is positioned to pivot toward a vehicle occupant, as shown in FIG. 2, without contacting the occupant during deployment.

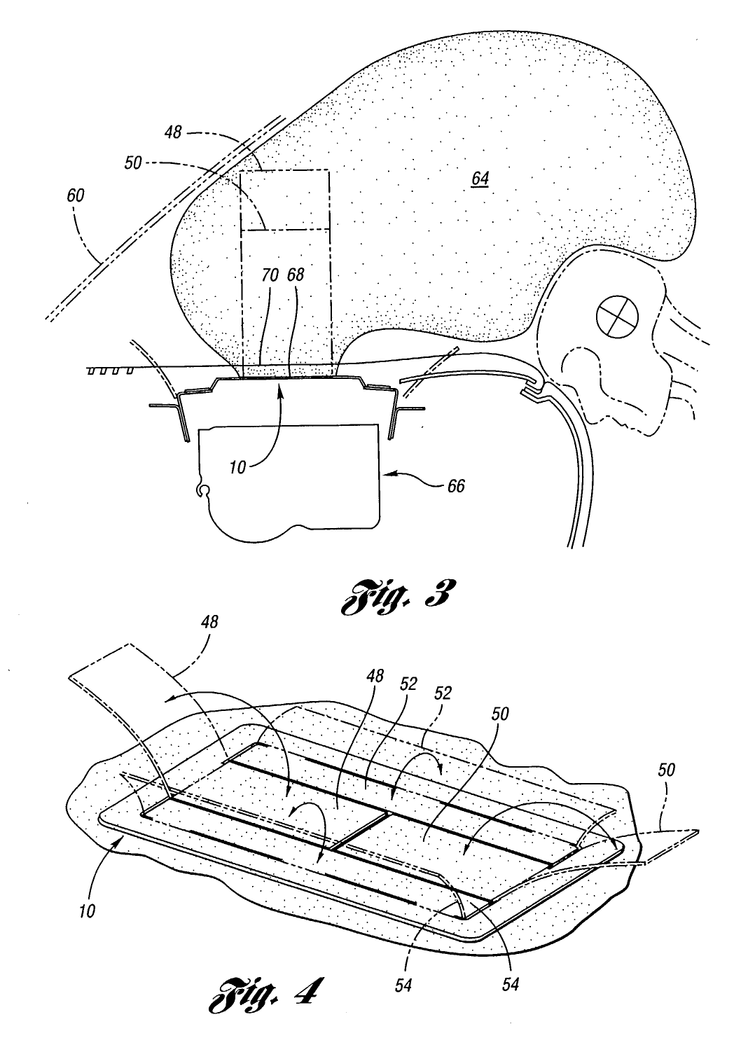

FIGS. 2 and 3 show cross-sectional views of the instrument panel member 10 positioned in a vehicle instrument panel 62, and the deployment of an air bag 64 from the air bag module 66.

The fourth deployment panel 54 is operative to direct the deploying air bag 64 angularly upward away from the occupant during an early stage of deployment of the air bag 64. This deployment is illustrated schematically in FIGS. 2 and 3. As the fourth deployment panel 54 pivots from the closed position to the fully open position, it contacts the deploying air bag 64 sufficiently to deflect the air bag slightly upward to avoid contact with the head of the out-of-position occupant during an early stage of deployment of the air bag 64.

In FIGS. 2 and 3, the first deployment panel 48 is illustrated to be longer than the second deployment panel 50, in this particular embodiment, so that the second deployment panel 50 does not contact the windshield 60 over the side of the vehicle.

Referring to FIG. 3, in this particular embodiment, the instrument panel member 10 is actually a cover 68 of the air bag module 66. The tear seam is formed directly in the cover 68. The cover 68 may be positioned under an instrument panel substrate, or may be covered with foam and skin 70 to form a class “A” surface of the vehicle.

FIG. 4 shows a perspective view of the instrument panel member 10, and illustrates, in phantom, the deployed first, second, third and fourth deployment panels 48, 50, 52, 54. The phantom illustrations of FIG. 4 show the panels in the open position.

While the best mode for carrying out the invention has been described in detail, those familiar with the art to which this invention pertains will recognize various alternative designs and embodiments for practicing the invention within the scope of the appended claims.

1. An instrument panel for a vehicle having an air bag positioned for deployment through an instrument panel member, the instrument panel member having a tear seam formed therein to facilitate such deployment, the vehicle instrument panel comprising:
the tear seam being configured to define four separate pivotable deployment panels in the instrument panel member, each such panel being pivotable in a direction away from the air bag as it deploys.

2. The vehicle instrument panel of claim 1, wherein two of said four pivotable deployment panels are cross-car deployment panels which are positioned to pivot laterally in the vehicle during deployment.

3. The vehicle instrument panel of claim 2, wherein distal ends of said two cross-car deployment panels are arranged to extend toward each other, separated by a portion of the tear seam.

4. The vehicle instrument panel of claim 2, wherein a third of said four pivotable deployment panels is positioned to pivot toward a windshield of the vehicle without contacting the windshield during deployment.

5. The vehicle instrument panel of claim 4, wherein a fourth of said four pivotable deployment panels is positioned to pivot toward a vehicle occupant without contacting the occupant during deployment and to direct the deploying air bag angularly upward away from the occupant during an early stage of deployment of the air bag.

6. The vehicle instrument panel of claim 1, wherein said instrument panel member comprises a cover for an air bag module which encloses the air bag.

7. The vehicle instrument panel of claim 1, wherein said instrument panel member comprises an instrument panel substrate.

8. The vehicle instrument panel of claim 1, wherein ends of tear seam include curved portions to prevent tearing of the instrument panel member as the panels deploy.

9. A vehicle instrument panel member having a tear seam formed therein to facilitate deployment of an air bag through the instrument panel member, the vehicle instrument panel member comprising:
four separate pivotable deployment panels defined by the tear seam for pivotal movement in four separate directions, respectively, away from each other during deployment of the air bag.

10. The vehicle instrument panel of claim 9, wherein two of said four pivotable deployment panels are cross-car deployment panels which are positioned to pivot in first and second opposing directions.

11. The vehicle instrument panel of claim 10, wherein distal ends of said two cross-car deployment panels are arranged to face each other, separated only by a portion of the tear seam.

12. The vehicle instrument panel of claim 10, wherein a third and fourth of said four pivotable deployment panels are positioned to pivot in third and fourth directions, respectively, perpendicular to said first and second directions.

13. The vehicle instrument panel of claim 12, wherein said fourth pivotable deployment panel is positioned to direct the deploying air bag angularly upward away from a vehicle occupant during an early stage of deployment of the air bag.

14. The vehicle instrument panel of claim 9, wherein said instrument panel member comprises a cover for an air bag module which encloses the air bag.

15. A vehicle instrument panel member having a tear seam formed therein to facilitate deployment of an air bag through the instrument panel member, the vehicle instrument panel member comprising:
four separate pivotable deployment panels defined by the tear seam for pivotal movement in four separate directions, respectively, away from each other during deployment of the air bag;
wherein two of said four pivotable deployment panels are cross-car deployment panels which are positioned to pivot in first and second opposite directions extending along the length of the vehicle instrument panel member.

16. The vehicle instrument panel member of claim 15, wherein said instrument panel member comprises a cover for an air bag module which encloses the air bag.

17. The vehicle instrument panel member of claim 15, wherein said instrument panel member comprises an instrument panel substrate.

18. A tear seam pattern for a vehicle instrument panel member comprising:
a straight first portion having first and second ends;
second and third straight, parallel portions intersecting said first and second ends, respectively, each of said second and third straight, parallel portions being perpendicular to said first portion, and each having two distal ends;
fourth, fifth, sixth and seventh straight, parallel portions each intersecting a distal end of one of said second and third straight, parallel portions, each of said fourth, fifth, sixth and seventh straight, parallel portions being parallel with the said first portion, wherein said first, second, third, fourth, fifth, sixth and seventh portions form four separate pivotable deployment panels in the instrument panel member.

19. The tear seam pattern of claim 18, wherein each of said fourth, fifth, sixth and seventh straight, parallel portions has a curved end to prevent tearing of the respective deployment panels during deployment.
